(19) United States
(12) Patent Application Publication
(10) Pub. No.: US 2026/0133521 A1
(43) Pub. Date: May 14, 2026

(54) IMAGE FORMING APPARATUS AND CONTROL METHOD OF CONTROLLING THE SAME

(71) Applicant: Sharp Kabushiki Kaisha, Osaka (JP)

(72) Inventor: Ryotaro KURODA, Osaka (JP)

(21) Appl. No.: 19/365,781

(22) Filed: Oct. 22, 2025

(30) Foreign Application Priority Data
Nov. 8, 2024 (JP) 2024-195707

(51) Int. Cl. G03G 15/043; G03G 15/04

(52) U.S. Cl. CPC G03G 15/043; G03G 15/04072; G03G 2215/0404

(57) ABSTRACT

An image forming apparatus that performs color printing by using a digital type laser driver having an automatic adjustment function of a bias current that includes a laser light emitter that emits laser light to expose a photoreceptor, a current controller that controls an APC light emission current of the laser light emitter, and a signal generator that generates a signal to cause the laser driver to calculate the bias current from a current value by a plurality of APC light emissions of the laser light emitter, wherein the signal generator generates a signal to cause the laser driver to calculate the bias current based on the current value by the plurality of APC light emissions from the laser light emitter at a timing outside a printing area in a sub-scanning direction in bias current calculation of the laser light emitter that performs exposure of a predetermined color.

### TECHNICAL FIELD

The disclosure relates to an image forming apparatus and the like that form a color image by scanning a photoreceptor with laser light. Note that the disclosure is based on JP 2024-195707 filed in Japan on Nov. 8, 2024, the contents of which are incorporated herein by reference.

### BACKGROUND ART

In the related art, in an image forming apparatus, a photoreceptor drum is exposed by a light beam emitted from a semiconductor laser as a light source to form an electrostatic latent image. In the image forming apparatus, Automatic Power Control (APC) is adopted in which a light receiving element such as a photo diode receives light so that light of a target quantity is stably emitted from the semiconductor laser, and a drive current of the semiconductor laser is controlled based on a received light quantity, in order to suppress a fluctuation in the light quantity.

### SUMMARY

### Technical Problem

However, there was a problem: there is a risk that when an image is formed, a response of the semiconductor laser is changed and thus streak-like or band-like density unevenness occurs.

The disclosure provides an image forming apparatus and the like capable of suppressing density unevenness of an image.

### Solution to Problem

The disclosure is an image forming apparatus that performs color printing by using a digital type laser driver having an automatic adjustment function of a bias current that includes a laser light emitter that emits laser light to expose a photoreceptor, an APC current controller that controls an APC light emission current of the laser light emitter, and an APC control signal generator that generates a signal to cause the laser driver to calculate the bias current from a current value by a plurality of APC light emissions of the laser light emitter, wherein the APC control signal generator generates the signal to cause the laser driver to calculate the bias current based on the current value by the plurality of APC light emissions from the laser light emitter at a timing outside a printing area in a sub-scanning direction in bias current calculation of the laser light emitter that performs exposure of a predetermined color.

The disclosure is a method of controlling an image forming apparatus that performs color printing by using a digital type laser driver having an automatic adjustment function of a bias current that includes (a) emitting laser light to expose a photoreceptor from a laser light emitter, (b) controlling an APC light emission current of the laser light emitter, and (c) generating a signal to cause the laser driver to calculate the bias current from a current value by a plurality of APC light emissions of the laser light emitter, wherein in step (c), a signal to cause the laser driver to calculate the bias current is generated based on the current value by the plurality of APC light emissions from the laser light emitter at a timing outside a printing area in a sub-scanning direction in bias current calculation of the laser light emitter that performs exposure of a predetermined color.

### Advantageous Effects of Disclosure

According to an image forming apparatus and the like of the disclosure, an excellent effect of suppressing density unevenness of an image can be exhibited.

### BRIEF DESCRIPTION OF DRAWINGS

FIG. 1 is an external view of an image forming apparatus according to an embodiment.

FIG. 2 is a control block diagram of the image forming apparatus.

FIG. 3 is a circuit diagram of a signal transmission path of a laser light emitter and a laser driver of the image forming apparatus.

FIG. 4 is an explanatory diagram of a mechanical configuration of an optical scanner.

FIG. 5 is an explanatory graph of adjustment of a bias current of APC.

FIG. 6 is an explanatory graph of a variation in adjustment of the bias current of the APC.

FIG. 7A is an explanatory graph of response characteristics of a semiconductor laser, and is a graph showing a change in a drive current Iop.

FIG. 7B is an explanatory graph of the response characteristics of the semiconductor laser, and is a graph showing a relationship of photon number fluctuation.

FIG. 8A is an image diagram for explaining density unevenness of a printed image, and is an explanatory diagram in a case where the APC is performed for each scan.

FIG. 8B is an image diagram for explaining density unevenness of a printed image, and is an explanatory diagram in a case where the APC is performed at a timing outside a printing area in a sub-scanning direction.

FIG. 9A is an explanatory diagram of timing when the APC is performed, and is an explanatory diagram in a case where the APC is performed for each of colors of K (black), C (cyan), M (magenta), and Y (yellow) for each scan in the sub-scanning direction.

FIG. 9B is an explanatory diagram of the timing when the APC is performed, and is an explanatory diagram in a case where the APC is performed for the K color outside the printing area in the sub-scanning direction.

FIG. 10 is an explanatory diagram of droop characteristics of the semiconductor laser.

FIG. 11 is an explanatory diagram of a setting example, by a user interface of the APC performed at the timing outside the printing area in the sub-scanning direction and the APC performed for each scan.

### DESCRIPTION OF EMBODIMENTS

In a general image forming apparatus, a photoreceptor drum is exposed by a light beam emitted from a semiconductor laser as a light source to form an electrostatic latent image. Since I-L (current-light quantity) characteristics of the semiconductor laser have temperature dependency, a light quantity of the emitted light beam fluctuates according to a fluctuation of a temperature of a use environment.

Therefore, in a digital laser driver, Automatic Power Control (APC) is adopted in which a light receiving element such as a photo diode receives light so that light of a target quantity is stably emitted from the semiconductor laser, and a drive current of the semiconductor laser is controlled based on a received light quantity, in order to suppress a fluctuation in the light quantity.

As for a method of obtaining a threshold current Ith which is a light emission start current of a semiconductor laser, PTL 1 discloses a method of setting a ratio of two light quantities Po_M and Po_L uniformly when the threshold current Ith is calculated based on I-L (current-light quantity) characteristics of the semiconductor laser, obtaining the threshold current Ith from two different current values of currents Iop_M and Iop_L caused to flow when the different light quantities Po_M and Po_L are emitted by the following equation (1), and setting a laser bias current Ib.

$$Ith = ( m \times Iop\_L - n \times Iop\_M ) / ( m + n ) \qquad ( 1 )$$

Here, n<m≤1.

Additionally, as a technique for suppressing a decrease in setting accuracy of a bias current value, a dedicated circuit including a plurality of sw circuits can be used in a laser drive to set the threshold current Ith.

However, in bias current adjustment of a digital type laser driver, when two light emission modes are switched (to obtain the two light quantities Po_M and Po_L), to obtain the threshold current Ith, and set a bias current, internal adjustment values of the respective modes vary, and thus the bias current Ib varies within a width substantially twice the internal adjustment values in total for each adjustment.

There was a problem: there is a risk that, when the bias current Ib unevenly varies, a response of the semiconductor laser changes, and thus streak-like or band-like density unevenness occurs in halftone printing of, for example, black (a K color) for which a density step is easily recognized even by visual observation.

Further, as described above, there was a problem: a method of mounting a dedicated circuit is not applicable to a general-purpose driver environment.

In order to solve one or more of the following problems, an embodiment of the disclosure will be described below with reference to the drawings.

Note that the following embodiment is an example for explaining the disclosure, and the technical scope of the disclosure described in the claims is not limited to the following description.

### 1. Embodiment

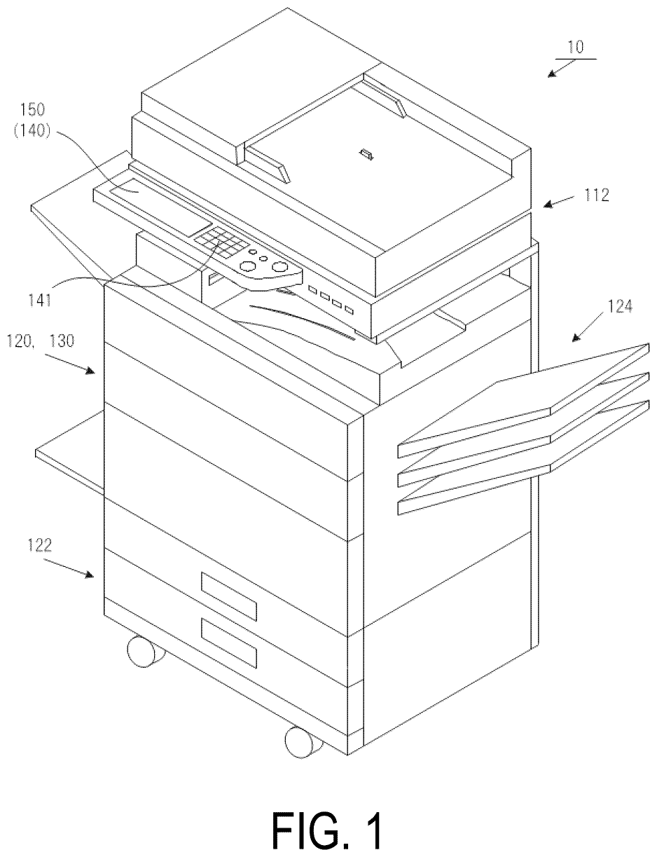

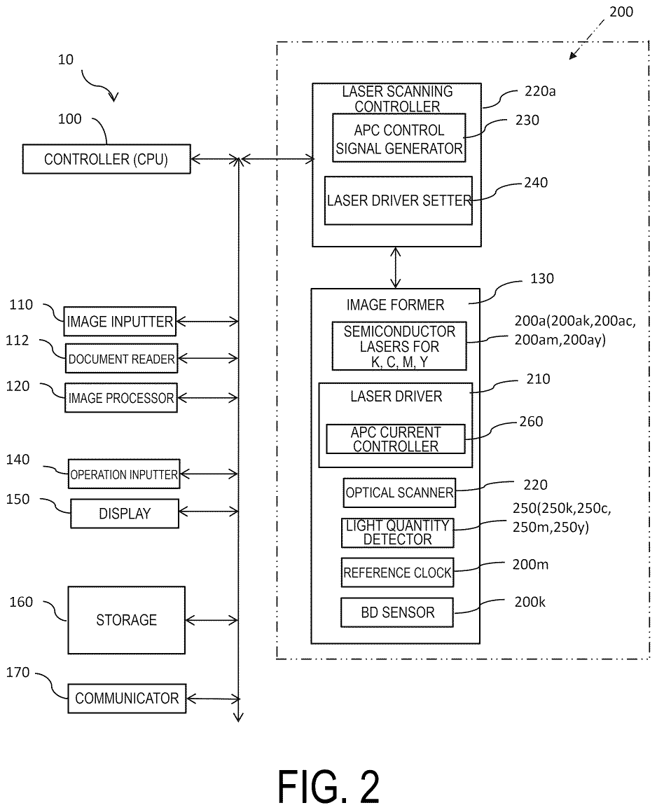

First, a configuration of an image forming apparatus 10 according to the embodiment will be described. FIG. 1 is an external view of the image forming apparatus 10 equipped with an optical scanning device 200 according to the embodiment, and FIG. 2 is a control block diagram of the image forming apparatus 10 and the optical scanning device 200.

### 1.1 Overall Configuration

As illustrated in FIG. 1, the image forming apparatus 10 is an information processing apparatus that includes a document reader 112 at an upper portion of the image forming apparatus 10, reads an image of a document, and outputs the image by an electrophotographic system. Examples of the image forming apparatus 10 include a multifunction printer.

As illustrated in a control system diagram of FIG. 2, the image forming apparatus 10 mainly includes a controller 100, an image inputter 110, a document reader 112, an image processor 120, an image former 130, an operation inputter 140, a display 150, a storage 160, and a communicator 170, and also has a function of the optical scanning device 200.

### 1.2 Image Forming Apparatus 10

The controller 100 is a function unit for controlling the image forming apparatus 10 as a whole.

Then, the controller 100 enables various functions by reading and executing various programs, and is configured with, for example, one or more arithmetic devices (for example, a Central Processing Unit (CPU)), and the like.

The image inputter 110 is a function unit for reading image data input to the image forming apparatus 10. Then, the image inputter 110 is connected to the document reader 112, which is a function unit that reads an image of a document, and image data output from the document reader 112 is input to the image inputter 110.

Further, image data may be input to the image inputter 110 from a recording medium such as a USB memory or an SD card. Further, image data may be input from another terminal device by the communicator 170 that establishes a connection with the other terminal device.

The document reader 112 has a function of optically reading a document placed on a contact glass (not illustrated) and passing scan data to the image processor 120.

The image former 130 is a function unit for forming output data based on image data on a recording medium (for example, a recording sheet). For example, as illustrated in FIG. 1, a recording sheet is fed from a feed tray 122, an image is formed on a surface of the recording sheet in the image former 130, and then the recording sheet is discharged from a sheet discharge tray 124. The image former 130 is configured with a laser printer in which an electrophotographic process using an electrophotographic system is used.

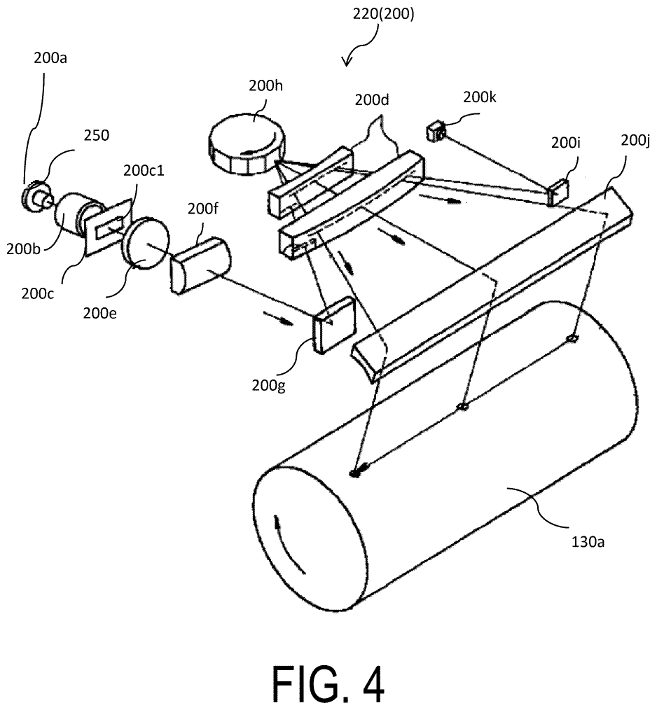

In the electrophotographic process of the image former 130, the optical scanning device 200 described below scans a surface of a photoreceptor drum 130a (image carrier) (refer to FIG. 4) with a laser beam (corresponding to laser light) corresponding to image data to form an electrostatic latent image, develops the electrostatic latent image with toner, and a developed toner image is transferred and fixed on a recording medium (recording sheet or the like) to form an image. In the image forming apparatus, the image former 130 includes the photoreceptor drum 130a for each of colors of K (black), C (cyan), M (magenta), and Y (yellow), and transfers and fixes images of the respective colors formed on the respective photoreceptor drums 130a onto the same recording medium to form a color image.

The image processor 120 has a function of, based on image data read by the document reader 112, performing conversion into a set file format (TIFF, GIF, JPEG, or the like). Then, an output image is formed based on the image data subjected to image processing.

The operation inputter 140 is a function unit for receiving an operation instruction from a user, and is configured with various key switches, a device that detects an input by contact, and the like. The user inputs a function to use and an output condition via the operation inputter 140.

The display 150 is a function unit for displaying various types of information to the user, and is configured with, for example, a Liquid Crystal Display (LCD) or the like.

That is, the operation inputter 140 provides a user interface for operating the image forming apparatus 10, and various setting menu screens and messages of the image forming apparatus are displayed on the display 150.

Note that, as illustrated in FIG. 1, the image forming apparatus 10 may be provided with a touch panel in which an operation panel 141 and the display 150 are integrally formed, as a configuration of the operation inputter 140. In this case, it is sufficient that a system for detecting an input to the touch panel is a general detection system such as a resistive film system, an infrared system, an electromagnetic induction system, or a capacitance system.

The storage 160 is a function unit in which various programs including a control program necessary for operation of the image forming apparatus 10, various data including read data, and user information are stored. The storage 160 is configured with, for example, a non-volatile Read Only Memory (ROM), a Random Access Memory (RAM), a Hard Disk Drive (HDD), or the like. Further, a Solid State Drive (SSD) being a semiconductor memory may be provided.

The communicator 170 establishes a communication connection with an external device. A communication interface (communication I/F) used for transmission and reception of data is provided as the communicator 170. With the communication I/F, data stored in the storage of the image forming apparatus 10 can be transmitted and received to and from another computer device connected via a network by an operation of the user in the image forming apparatus 10.

### 1.3 Optical Scanning Device 200

As illustrated in FIG. 2, the image forming apparatus 10 is equipped with the optical scanning device 200.

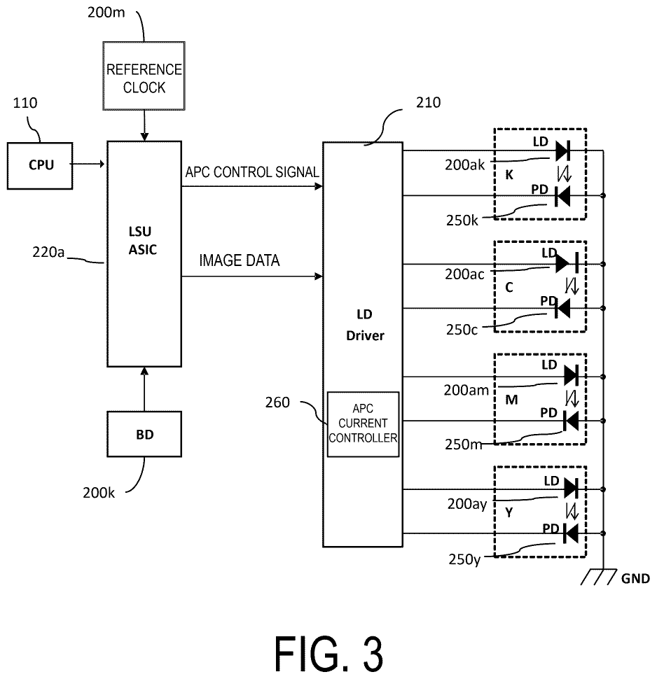

FIG. 3 is a specific circuit diagram of a signal transmission path around a laser driver 210 in the optical scanning device 200.

As illustrated in FIGS. 2 and 3, the optical scanning device 200 includes the photoreceptor drum 130a that forms an image by an electrophotographic system, a laser light emitter 200a including a semiconductor laser (Laser Device (LD), also referred to as a laser diode) that emits laser light for forming an electrostatic latent image on the photoreceptor drum, the digital type laser driver (also referred to as a Laser Diode Driver (LDD)) 210 that controls the laser light emitter 200a so that a light emission quantity increases or decreases in proportion to an analog signal to which a current corresponding to an excess from a bias current is input, an optical scanner 220 that performs scanning onto the photoreceptor drum 130a as a target object with laser light emitted from the laser light emitter 200a, a light quantity detector 250 that detects a light quantity of laser light emitted by the laser light emitter 200a, a laser driver setter 240 that sets an APC light quantity of the laser light emitter 200a, and an APC control signal generator 230 that generates a signal to cause the laser driver 210 to calculate a bias current from a current value of a plurality of APC light emissions of the laser light emitter 200a.

The APC control signal generator 230 generates, in bias current calculation of the laser light emitter 200a that exposes a predetermined color (in the embodiment, the K (black) color), a signal to cause the laser driver 210 to calculate a bias current, based on a current value by a plurality of APC light emissions from the laser light emitter 200a at a timing outside a printing area in a sub-scanning direction.

The laser driver setter 240 sets an APC light quantity and a bias current of the laser light emitter 200a.

Since the image former 130 forms a color image, the photoreceptor drums 130a, the optical scanners 220, the laser light emitters 200a, the light quantity detectors 250, and the like are provided for the respective colors of K (black), C (cyan), M (magenta), and Y (yellow), and as illustrated in FIGS. 2 and 3, the laser light emitters 200a that emit laser light toward the photoreceptor drums 130a for the respective colors of K, C, M, and Y are denoted by reference numerals 200ak, 200ac, 200am, and 200ay, respectively, and the light quantity detectors 250 are denoted by reference numerals 250k, 250c, 250m, and 250y, respectively.

As illustrated in FIGS. 2 and 3, in the optical scanning device 200, the optical scanner 220 includes a laser scanning controller 220a as a control system, and the laser scanning controller 220a inputs image date output from the image processor 120 or the storage 160 to the laser driver 210 by a control signal of the controller 100, and is configured with an application specific integrated circuit (LSUASIC). A reference clock signal 200m and a detection signal of a BD sensor 200k are input to the integrated circuit (LSUASIC) of the laser scanning controller 220a.

Image data is sequentially read from the storage 160 according to an irradiation position of a laser beam with respect to a surface of the photoreceptor drum 130a in a main scanning direction, based on the detection signal of the BD sensor 200k.

Further, an APC current controller 260 controls a light emission quantity of the laser light emitter 200a detected by the light quantity detector 250, based on a control signal generated by the APC control signal generator 230 and an APC light quantity set in the laser driver setter 240, to control (Automatic Power Control (APC)) the light emission quantity of the laser light emitter 200a to be a target light quantity.

The light quantity detector 250 includes, for example, a Photo Diode (PD) being a light quantity detection element disposed in a vicinity of a laser light emitting element of the laser light emitter 200a. Further, in the APC current controller 260, a system is adopted in which an optical output (optical power) P of the laser light emitter 200a detected by the light quantity detector 250 is monitored, and a drive current of the laser light emitter 200a is automatically controlled so that the optical output becomes a target light quantity.

FIG. 4 illustrates a mechanical configuration of the optical scanner 220 in the optical scanning device 200.

As illustrated in FIG. 4, the optical scanner 220 performs scanning on the photoreceptor drum 130a with laser light to form an electrostatic latent image on the photoreceptor drum 130a. As described above, the image former 130 is provided with the photoreceptor drums 130a, the optical scanners 220, the laser light emitters 200a, the light quantity detectors 250, and the like for the respective colors of K (black), C (cyan), M (magenta), and Y (yellow).

In the optical scanning device 200, the laser light emitter 200a including a semiconductor laser light emitting element that generates a laser beam (laser light); and in an emission direction of the laser beam emitted from the laser light emitter 200a, a collimator lens 200b that converts an incident laser beam into a parallel beam, an aperture 200c formed of a plate-shaped member having an opening 200cl formed substantially at a center portion thereof, a concave lens 200e that enlarges an incident laser beam by a combination with an fθ lens 200d that enlarges a laser beam described below in a scanning direction, a cylindrical lens 200f, and an incident beam folding mirror 200g, are sequentially arranged.

Further, the fθ lens 200d and a polygon mirror 200h including a plurality of reflecting surfaces at an outer peripheral surface are arranged in order in a reflecting direction of a laser beam by the incident beam folding mirror 200g, and the fθ lens 200d, a reflecting mirror 200i, an emitted beam folding mirror 200j that performs surface tilt correction of the polygon mirror 200h, and the photoreceptor drum 130a are arranged in a reflecting direction of a laser beam by the reflecting surface of the polygon mirror 200h.

Reflected light reflected by the reflecting mirror 200i is detected by the beam detection sensor (BD sensor) 200k. The BD sensor 200k is an optical sensor that outputs a detection signal according to the magnitude of a received light quantity of a laser beam. The BD sensor 200k has a function of detecting reflected light from a start end side of a main scanning region of a laser beam (a scanning region along an axial direction of the photoreceptor drum 130a), and is used to control timing when an electrostatic latent image is written on the photoreceptor drum 130a. In general, a detection signal of the BD sensor 200k becomes trigger-like.

Further, the laser light emitter 200a is provided with the light quantity detector 250 including a photo diode (PD) that detects a laser emission quantity thereof in a vicinity thereof.

### 1.4 Control Principle of Semiconductor Laser

### Adjustment of Bias Current

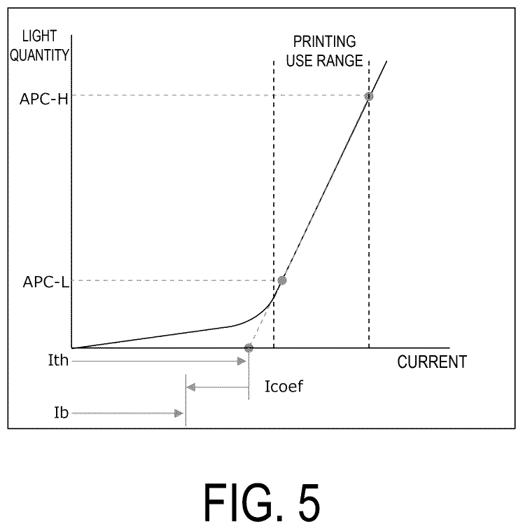

In the laser light emitter 200a of the semiconductor laser, a relationship between light quantity and current is as shown in FIG. 5, and a current having a value equal to or greater than the bias current Ib is supplied to the semiconductor laser to drive the semiconductor laser to emit light.

In the APC for the laser light emitter (semiconductor laser) 200a, as shown in FIG. 5, the threshold current Ith is determined, in light quantities within a printing use range, based on detected current values of the semiconductor laser at a low light quantity APC-L and a high light quantity APC-H (examples of respective light quantities of a plurality of APC light emissions) (in detail, the threshold current Ith is obtained based on change characteristics (optical output-forward current characteristics) of the respective detected current values for APC-H and APC-L). A current value obtained by subtracting a register setting value Icoef from the threshold current Ith is the bias current Ib (Ith−Icoef=Ib). Here, the register setting value Icoef is a setting value set in advance in the laser driver 210 (or the laser driver setter 240).

### Adjustment Variation of Bias Current

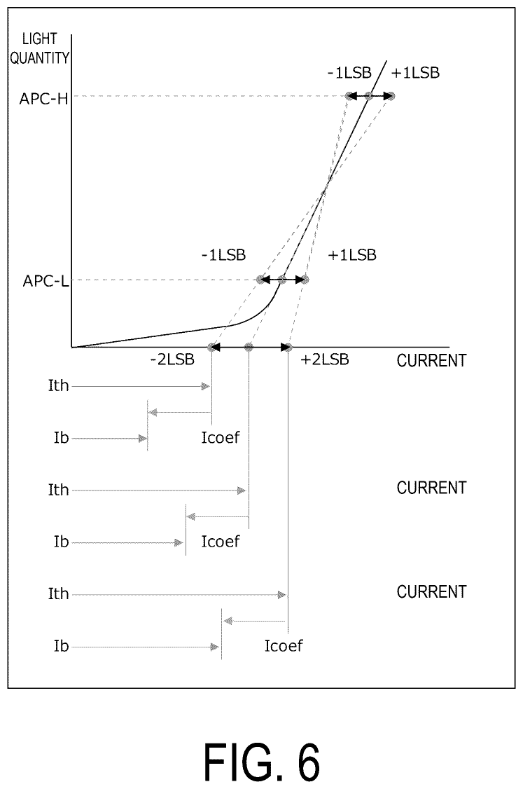

In the digital type laser driver, as shown in FIG. 6, the optical output-forward current characteristics of the semiconductor laser are affected by a temperature change, and a current value with respect to a light quantity fluctuates, so that it is considered that, at each of the high temperature light quantity APC-H and the low temperature light quantity APC-L, current changes of −LSB with a temperature decrease and of +LSB with a temperature increase occur, and current value adjustment errors of ±1 LSB occur as a whole.

Therefore, the bias current Ib varies because the threshold current Ith changes within a width of ±2 LSB in total at each adjustment.

Note that an optical output of the semiconductor laser (laser diode) decreases due to an increase in temperature. This is because, when the semiconductor laser is energized for a long time, heat is generated at a junction portion and an element temperature rises, and heat dissipation is insufficient, a case temperature rises and an optical output decreases, and therefore, in order to maintain a predetermined optical output, it is necessary to cause a larger current to flow through the semiconductor laser.

### Response Characteristics of Semiconductor Laser

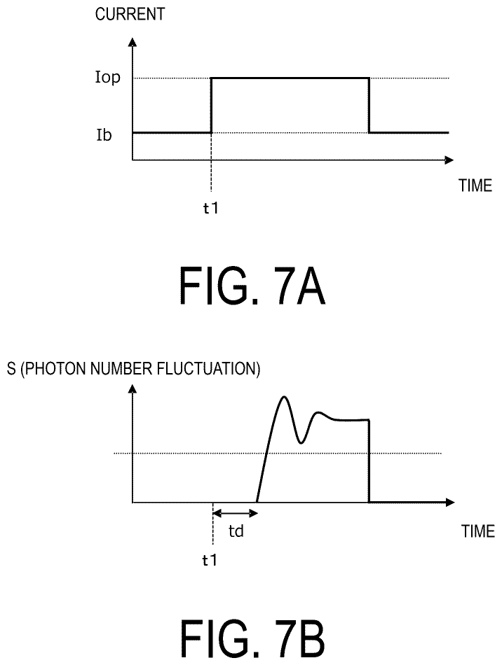

The variation in the bias current Ib also adversely affects the response characteristics of the semiconductor laser. That is, with respect to a change in the drive current Iop (time t1) shown in FIG. 7A, in a photon number fluctuation S (output light quantity change) shown in FIG. 7B, an oscillation delay time ta from the time t1 is derived as follows from a rate equation of the following equation (2).

$${t}_{d} = {τ}_{s} l o {g}_{e} \{ ( Iop - Ib ) / ( Iop - Ith ) \} \qquad ( 2 )$$

Where τₛ: carrier lifetime

Therefore, since the semiconductor laser has a characteristic that a response becomes faster as the bias current Ib is brought close to the threshold current Ith (since ta approaches 0), it is necessary to set the bias current accurately also from the viewpoint of the response characteristic.

In the image forming apparatus, it is conceivable that the laser light emitter 200a repeats heat generation and heat dissipation during printing to repeat temperature changes, and due to the temperature changes, as shown in FIG. 6, the bias current set by the APC becomes inappropriate, and an appropriate current is not supplied to the laser light emitter, and an influence of density unevenness occurs after all.

### Density Unevenness of K (Black) Color

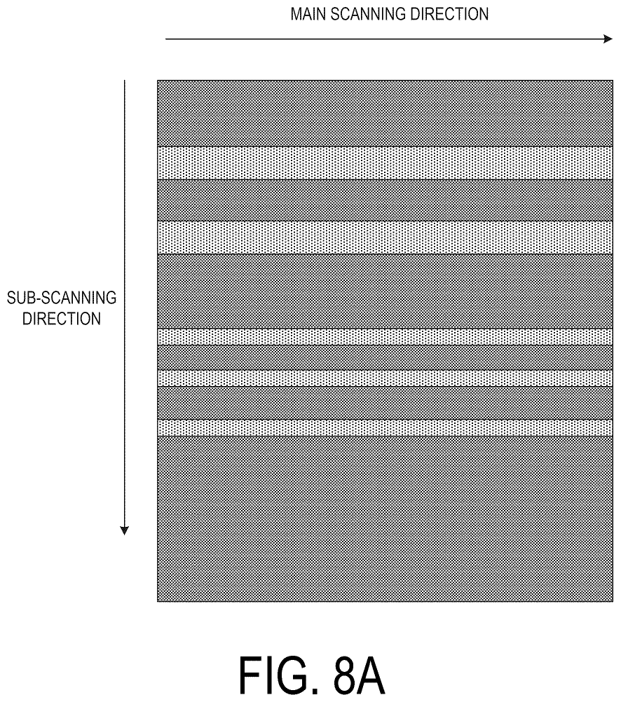

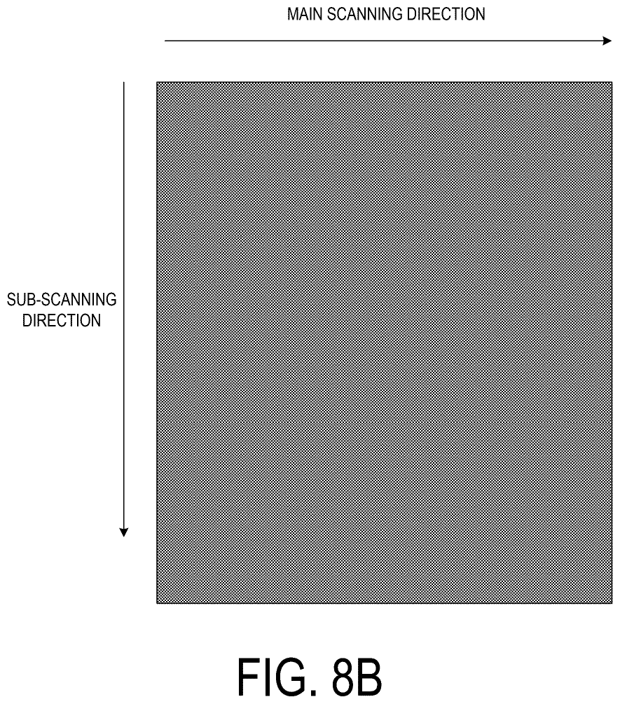

In printing of a halftone image, FIG. 8A is an explanatory diagram of a case where the APC is performed for each of the colors of K (black), C (cyan), M (magenta), and Y (yellow) for each scan, and FIG. 8B is an explanatory diagram of a case where the APC is performed for the K color outside the printing area in the sub-scanning direction.

As illustrated in FIG. 8A, in a case where the digital type laser driver was used in halftone printing, when the APC was performed for each scan, density unevenness occurred in a K color page, in some cases. On the other hand, the C, M, and Y colors each have a characteristic that since a density step is unlikely to be recognized by visual observation in the first place, even if a density step occurs, the density step is hard to be recognized.

Therefore, in a case where the APC is performed for the semiconductor laser for each of the K, C, M, and Y colors, when the semiconductor laser for the K color is driven in a constant ON state without performing the APC for the K color within the printing area in the sub-scanning direction, and on the other hand, the APC is performed for the C, M, and Y colors including the K color outside the printing area in the sub-scanning direction, as illustrated in FIG. 8B, it is understood that noticeable density unevenness does not occur in a printed image.

As described above, in the embodiment, the APC control signal generator 230 generates, in bias current calculation of the laser light emitter 200a that exposes a predetermined color (in the embodiment, the K (black) color), a signal to cause the laser driver to calculate the bias current is generated, based on the current value by the plurality of APC light emissions from the laser light emitter 200a at the timing outside the printing area in the sub-scanning direction.

### 1.5 Control Contents of Embodiment

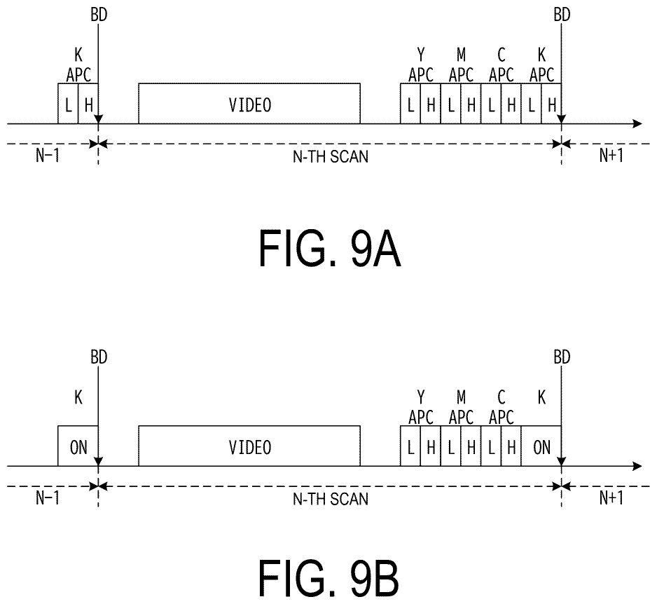

FIGS. 9A and 9B are each a specific timing chart of signals generated by the APC control signal generator 230 to cause the laser driver to calculate the bias current. FIG. 9A is a diagram for explaining APC control at the timing outside the printing area in the sub-scanning direction for the K color, and FIG. 9B is a diagram for explaining the APC control for the K (black) color at a timing within the printing area in the sub-scanning direction. Note that an N-th scan among scans in the sub-scanning direction is exemplified. In FIGS. 9A and 9B, “VIDEO” indicates a mode in which light is emitted according to print data, and ON indicates a mode in which light is forcibly emitted without performing the APC.

As illustrated in FIG. 9A, at the timing outside the printing area in the N-th scan, the APC is performed for all of K (black), C (cyan), M (magenta), and Y (yellow).

On the other hand, FIG. 9B illustrates the APC at the timing within the printing area in the sub-scanning direction in the N-th scan. Within the printing area, a mode is used in which the APC is performed for C (cyan), M (magenta), and Y (yellow), but the APC is not performed for K (black) and light is forcibly emitted (indicated by “ON” in FIG. 9B). Note that in a portion in the mode in which light is forcibly emitted (ON) for K (black), the light is used for generating a Beam Detect (BD) signal, and an (N+1)-th scan is started at timing when the BD signal is received in the N-th scan. Note that the BD signal is a synchronization signal output during scanning, and may be referred to as a Start Of Scan (SOS) signal. An optical sensor is disposed on a scanning line of laser light or at a position where reflection is received from above the scanning line, a BD signal is generated at timing when light is detected (BeamDetect), and the BD signal is used for synchronization in a horizontal direction.

### 1.6 Effects of Embodiment

Therefore, in the embodiment, it is possible to suppress density unevenness for the K (black) color that is easily recognized. Further, for the C (cyan), M (magenta), and Y (yellow) colors, it is possible to suppress color unevenness in the sub-scanning direction as in the related art.

Therefore, according to the embodiment, since the bias current of the K (black) color does not change during printing and a response of the semiconductor laser does not change, occurrence of streak-like or band-like density unevenness caused by an uneven variation in the adjustment of the bias current is prevented. Further, since the APC is performed even during printing, the C (cyan), M (magenta), and Y (yellow) colors are hardly affected by droop characteristics of a laser, and color unevenness in the sub-scanning direction can be suppressed.

### 2. Modification 1

Modification 1 in which the droop characteristics of the semiconductor laser are considered will be described.

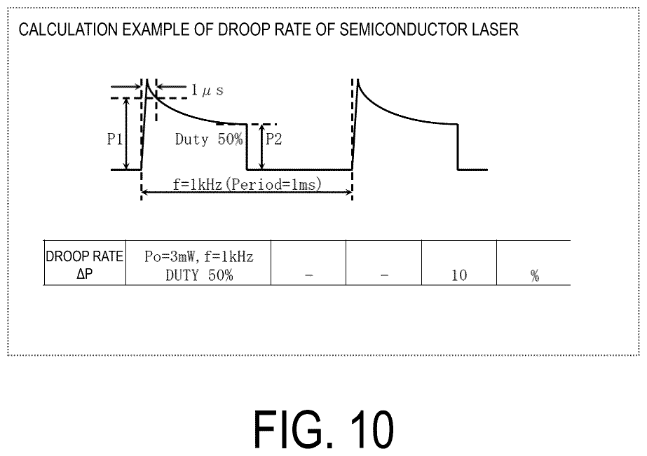

The semiconductor laser has a characteristic that a light quantity decreases along with an increase in temperature or a lapse of driving time when the semiconductor laser is driven while being lit with a constant current (droop characteristics), and thus the light quantity decreases with the lapse of time. Here, a rate of decrease in light quantity (droop rate) due to a change in time can be expressed by the following equation (3) with reference to a graph of light quantity with respect to current of the semiconductor laser shown in FIG. 10.

$$Δ P = ( P 1 - P 2 ) / P 2 \times 100 [ \% ] \qquad ( 3 )$$

Note that a maximum output during a period from 1 μs (microsecond) after a rise of an optical power to a fall is defined as P1, and the optical power at the fall is defined as P2. Conditions are a temperature Tc=25° C., a rated maximum output P0=3 mw, f=1 kHz, Duty=50%, and ΔP is 10%.

In a case where the APC is performed for the semiconductor laser for the K color at the timing outside the printing area in the sub-scanning direction, and the APC is not performed within the printing area, when continuous light emission continues as in a case of solid printing (that refers to a state in which a printing surface is covered with a single color without gradation) within the printing area, a line width and a dot diameter in a latter half of a page become small.

Therefore, in Modification 1, in a case where only characters are printed (character printing mode) in a facsimile or the like, the APC control signal generator 230 generates a signal to cause the laser driver 210 to calculate the bias current for each scan even at the timing within the printing area, thereby improving printing quality and being preferable.

That is, in the character printing mode in which only characters are printed in a facsimile or the like, there is no halftone region, and therefore, it is considered that there is no need to take care (treatment) of streak-like or band-like density unevenness caused by an uneven variation in the adjustment of the bias current. On the other hand, when the APC is not performed during printing, a line may become thin due to the influence of the droop characteristics. Thus, in the character printing mode, the APC can be performed for each scan to suppress the influence of the droop characteristics, thereby improving the printing quality.

Therefore, as in Modification 1, the influence of the droop characteristics can be suppressed by performing the APC in a case of the high-density printing of characters or the like.

### 3. Modification 2

In Modification 2, timing when the signal for causing the laser driver 210 to calculate the bias current is generated by the APC control signal generator unit 230 can be optionally switched between the timing outside the printing area in the sub-scanning direction and every scan by a user interface.

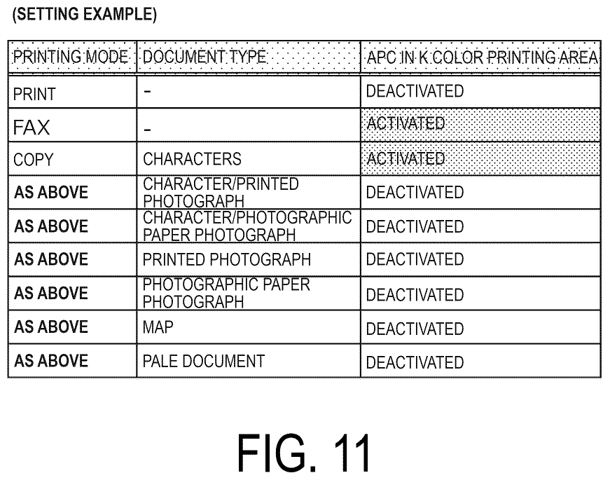

As illustrated in a setting example of FIG. 11, in Modification 2, whether to activate or deactivate the APC in a printing area of the K color (within the printing area in the sub-scanning direction) can be switched by an input from the operation inputter 140 (user interface) or the operation panel 141 in job combinations of a printing mode (print, facsimile (FAX), copy), and a document type (character, character/printed photograph, character/photographic paper photograph, printed photograph, photographic paper photograph, map, pale document).

In a mode in which characters are mainly printed, it is better to perform the APC in order to suppress the influence of the droop characteristics, and therefore, in Modification 2, setting of the activation and the deactivation of the APC is enabled for each mode by the operation inputter 140 or the operation panel 141, user's preference can be met.

In the setting example illustrated in FIG. 11, in a facsimile mode and a case where characters are printed in a copy mode, activation of performing the APC in the printing area of the K color (within the printing area in the sub-scanning direction) is set, and in other cases, deactivation of the APC in the printing area of the K color is set. FIG. 11 is an example, and another setting can be made according to the user's preference.

Although the embodiment has been described above, specific configurations are not limited to the embodiment, and designs and the like within a scope not departing from the gist of the disclosure are also included in the scope of the claims.

Further, in the embodiment, a program operating on each apparatus is a program that controls a CPU or the like (a program for causing a computer to function) to enable the functions of the above-described embodiment. Then, information handled by these apparatuses is temporarily accumulated in a transitory storage apparatus (for example, a RAM) at the time of processing, is then stored in a storage apparatus such as various ROMs or an HDD, and is read, corrected, and written by the CPU as needed.

A recording medium storing the programs may be any of a semiconductor medium (for example, a ROM, a non-volatile memory card, or the like), an optical recording medium or a magneto-optical recording medium (for example, a Digital Versatile Disc (DVD), a magneto Optical Disc (MO), a Mini Disc (MD), a Compact Disc (CD), BD, or the like), a magnetic recording medium (for example, a magnetic tape or a flexible disk), and the like, as far as the recording medium is a non-transitory recording medium.

Further, not only are the functions of the above-described embodiment enabled by executing a loaded program, but the functions of the disclosure may also be enabled by processing in cooperation with an operating system or another application program or the like, based on instructions from the program.

Further, when a program is distributed in the market, the program can be stored in a portable storage apparatus and distributed, or can be transferred to a server computer connected via a network such as the Internet. In this case, it is obvious that a storage apparatus of the server computer is also included in the disclosure.

Further, a part or all of the respective devices in the above-described embodiment may be achieved as a Large Scale Integration (LSI) that is typically an integrated circuit. Each functional block of each device may be individually formed into a chip, or a part or all of the functional blocks may be integrated into a chip. Further, the method of circuit integration is not limited to LSIs, and may be achieved by a dedicated circuit or a general-purpose processor. Further, when a technology of circuit integration that can replace LSIs emerges due to advances in semiconductor technology, it will, of course, be possible to use integrated circuits based on the technology.

### DESCRIPTION OF SYMBOLS

10 Image forming apparatus
100 Controller
130 Image former
130a Photoreceptor drum
140 Operation inputter
141 Operation panel
200 Optical scanning device
200a Laser light emitter
210 Laser driver
220 Optical scanner
220a Laser scanning controller
230 APC control signal generator
240 Laser driver setter
250 Light quantity detector
260 APC current controller

1. An image forming apparatus that performs color printing by using a digital type laser driver having an automatic adjustment function of a bias current, comprising:
a laser light emitter that emits laser light to expose a photoreceptor;
a current controller that controls an Automatic Power Control (APC) light emission current of the laser light emitter; and
a signal generator that generates a signal to cause the laser driver to calculate the bias current from a current value by a plurality of APC light emissions of the laser light emitter, wherein
the signal generator generates the signal to cause the laser driver to calculate the bias current based on the current value by the plurality of APC light emissions from the laser light emitter at a timing outside a printing area in a sub-scanning direction in bias current calculation of the laser light emitter that performs exposure of a predetermined color.

2. The image forming apparatus according to claim 1, wherein
the predetermined color is black, and the signal generator generates the signal to cause the laser driver to calculate the bias current for each scan even at a timing within the printing area in the sub-scanning direction for the laser light emitter that performs exposure of a color other than the predetermined color.

3. The image forming apparatus according to claim 1, wherein
the signal generator generates the signal to cause the laser driver to calculate the bias current for each scan including black that is the predetermined color even at a timing within the printing area in the sub-scanning direction in a character printing mode.

4. The image forming apparatus according to claim 1, wherein
the signal generator enables switching between APC performed at the timing outside the printing area in the sub-scanning direction and the APC performed for each scan, by a user interface.

5. A method of controlling an image forming apparatus that performs color printing by using a digital type laser driver having an automatic adjustment function of a bias current, comprising:
(a) emitting laser light to expose a photoreceptor from a laser light emitter;
(b) controlling an Automatic Power Control (APC) light emission current of the laser light emitter; and
(c) generating a signal to cause the laser driver to calculate the bias current from a current value by a plurality of APC light emissions of the laser light emitter, wherein
in step (c), a signal to cause the laser driver to calculate the bias current is generated based on the current value by the plurality of APC light emissions from the laser light emitter at a timing outside a printing area in a sub-scanning direction in bias current calculation of the laser light emitter that performs exposure of a predetermined color.
